(19) United States
(12) Patent Application Publication
(10) Pub. No.: US 2022/0120498 A1
(43) Pub. Date: Apr. 21, 2022

(54) GRAIN DRYING APPARATUS

(71) Applicant: Alan Hanratty, Fort Saskatchewan (CA)

(72) Inventor: Alan Hanratty, Fort Saskatchewan (CA)

(21) Appl. No.: 17/072,662

(22) Filed: Oct. 16, 2020

(51) Int. Cl. F26B 23/04; F26B 3/06; F26B 3/14; F26B 17/00; F26B 25/14; H02S 10/00

(52) U.S. Cl. CPC F26B 23/04; F26B 3/06; F26B 3/14; F26B 2200/06; F26B 25/14; H02S 10/00; F26B 17/001

(57) ABSTRACT

A grain drying apparatus configured to provide reduction of moisture of a grain disposed in a chamber thereof wherein the apparatus utilizes a photovoltaic power source. The present invention includes a housing having at least one wall, a bottom and a roof defining an interior volume. A heating chamber is present and is operable to provide heating of air for introduction into the grain drying apparatus. A heating coil assembly is operably coupled to the photovoltaic power source so as to provide heating of the air passing through the heating chamber. A first chamber is present wherein the first chamber is configured to receive grain therein. A second chamber is adjacent the first chamber and is operably coupled to the heating chamber. A void is present in the interior volume of the housing adjacent the second chamber. The wall intermediate the first and second chamber allows airflow therethrough.

### FIELD OF THE INVENTION

The present invention relates generally to grain drying and storage, more specifically but not by way of limitation, a grain dryer that is configured to receive grain therein and provide drying thereof wherein the grain dryer of the present invention is structured to utilize solar energy to warm the air and the dryer is further designed to reduce the amount of air volume required to be heated.

### BACKGROUND

As is known in the art, hundreds of millions of tons of wheat corn rice and other grains are dried in grain dryers. In the main agricultural countries, drying comprises the reduction of moisture from about 17-30% to values between 8 and 15% depending on the grain. The final moisture content for drying must be adequate for storage. The more oil the grain has, the lower its storage moisture content will be. Drying is carried out as a requisite for safe storage, in order to inhibit microbial growth. The largest dryers are normally used “off-farm”, in elevators, and are of the continuous type. The two main types of grain dryers are mixed-flow dryers and cross-flow dryers. Continuous flow dryers typically produce hundreds of tons of dried grain per day.

The depth of grain the air must traverse in dryers varies depending upon the type of dryer. Dryers normally consist of a bin, with heated air flowing horizontally from an internal cylinder through an inner perforated metal sheet, then through an annular grain bed, and finally across the outer perforated metal sheet, before being discharged to the atmosphere. The usual drying times range from 1 h to 4 h depending on how much water must be removed, type of grain, air temperature and the grain depth. Dryers are typically fed at the top and the grain is removed at the bottom of the bin by a sweeping auger. Regardless of the type of dryer most them utilize a heat source that is either gas or propane. A large amount of BTU production is required and as such large natural gas or propane burners are utilized to produce the required amount of heat to accomplish the grain drying. The hot air is distributed through the grain dryer via a fan. One risk of using propane or gas is the grain dryer/mill can catch fire and this has routinely occurred. Additionally, depending on the location of the grain dryer, the cost of the fuel can be expensive and as margins have diminished for grain in the commercial market it is advantageous to seek more cost effective solutions.

It is intended within the scope of the present invention to provide a grain dryer that utilizes photovoltaic panels to produce electricity sufficient to power a heating coil assembly and wherein the present invention further provides an optimized internal dryer structure.

### SUMMARY OF THE INVENTION

It is the object of the present invention to provide a grain dryer configured to receive grain therein and provide drying thereof wherein the grain dryer includes a plurality of photovoltaic panels configured to generate electricity.

Another object of the present invention is to provide a grain drying apparatus that provides a solar technique for heat generation and further provides an optimized internal structure for drying grain wherein the present invention includes a housing.

A further object of the present invention is to provide a grain dryer configured to receive grain therein and provide drying thereof wherein the grain dryer of the present invention includes a heating coil assembly operably coupled to the photovoltaic panels.

Still another object of the present invention is to provide a grain drying apparatus that provides a solar technique for heat generation and further provides an optimized internal structure for drying grain wherein the housing includes an interior volume having a first chamber proximate the exterior wall of the housing configured to receive grain therein.

An additional object of the present invention is to provide a grain dryer configured to receive grain therein and provide drying thereof wherein the grain dryer of the present invention includes a second chamber adjacent to the first chamber and distal to the exterior wall of the housing.

Yet a further object of the present invention is to provide a grain drying apparatus that provides a solar technique for heat generation and further provides an optimized internal structure for drying grain that further includes a fan configured to move air from the heating coil assembly chamber to the second chamber.

Another object of the present invention is to a provide a grain dryer configured to receive grain therein and provide drying thereof wherein the grain dryer of the present invention wherein the second chamber has an interior volume sized so as to require less energy to maintain the temperature of the air therein at the desired temperature to produce the grain.

An alternate object of the present invention is to provide a grain drying apparatus that provides a solar technique for heat generation and further provides an optimized internal structure for drying grain wherein the wall intermediate the first chamber and second chamber includes a plurality of apertures to facilitate air passage therethrough.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is an exemplary embodiment showing the exterior of the grain dryer; and

FIG. 2 is a cross sectional diagrammatic view of an embodiment of the present invention; and

FIG. 3 is a top sectional view of the interior volume of the housing of the present invention.

### DETAILED DESCRIPTION

Referring now to the drawings submitted herewith, wherein various elements depicted therein are not necessarily drawn to scale and wherein through the views and figures like elements are referenced with identical reference numerals, there is illustrated a grain drying apparatus 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

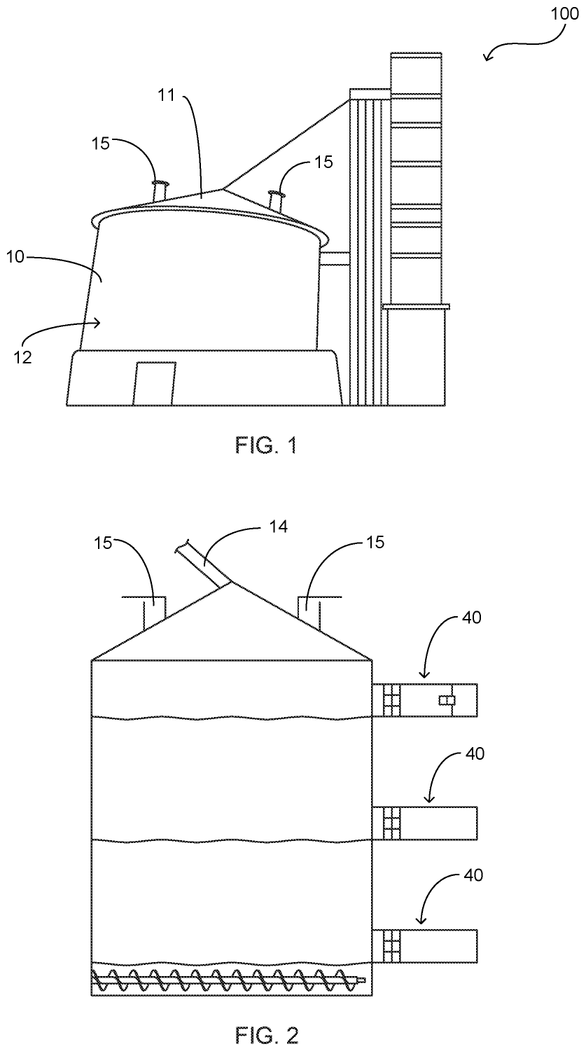

Now referring in particular to the Figures submitted as a part hereof, the grain drying apparatus 100 includes a housing 10. The housing 10 is manufactured from a suitable durable material such as but not limited to metal. The housing 10 includes a roof 11 and at least one wall 12 and has an interior volume 30 configured to receive grain therein from the feed tube 14. The roof 11 further includes vents 15 providing a technique to allow hot air to escape the interior volume 30 of the housing 10. It should be understood within the scope of the present invention that the illustration in FIG. 1 is exemplary and does not serve to limit the shape and/or style of the grain drying apparatus 100. It is contemplated within the scope of the present invention that the grain drying apparatus 100 could be formed in various shapes and sizes and achieve the desired objective described herein.

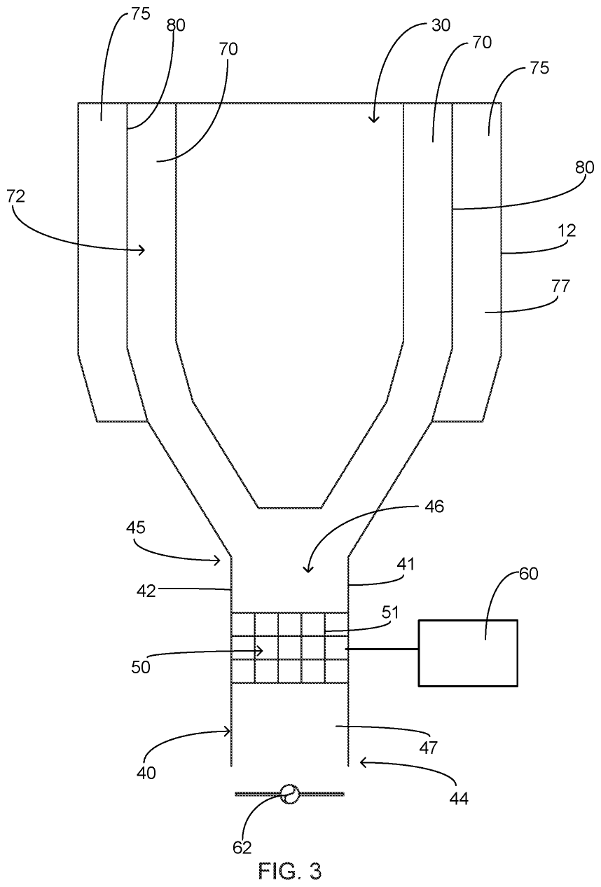

Referring now to FIGS. 2 and 3 submitted herewith, the grain drying apparatus 100 includes a heating chamber 40. The heating chamber 40 is defined by walls 41,42 and includes a first end 44 and second end 45 wherein the second end 45 includes an opening 46 providing an operable coupling with the interior volume 30. The heating chamber 40 is hollow having a passage 47 extending intermediate the first end 44 and second end 45. While the heating chamber 40 is illustrated herein as being rectangular in shape, it should be understood within the scope of the present invention that the heating chamber 40 could be provided in alternate shapes and sizes.

Disposed within the heating chamber 40 is the heating coil assembly 50. The heating coil assembly 50 includes a plurality of heating elements 51 that are operably coupled to the photovoltaic panel 60. The heating elements 51 are conventional electric heating elements and are manufactured from Nichrome or other suitable material. It should be understood within the scope of the present invention that the heating coil assembly 50 could be comprised of alternate quantities of heating elements 51 in order to produce the desired amount of hot air to be introduced into the second chamber 70. The heating coil assembly 50 is electrically coupled to a photovoltaic panel 60. The photovoltaic panel 60 is operably to produce a sufficient amount of electricity to operate the heating coil assembly 50. While one photovoltaic panel 60 is illustrated herein, it should be understood within the scope of the present invention that the grain drying apparatus 100 could have more than one photovoltaic panel 60. A fan 62 is present proximate the first end 44 of the heating chamber 40 and is operable to facilitate the movement of air from the heating chamber 40 into the interior volume 30 of the housing 10.

The interior volume of the housing 10 includes a first chamber 75 and a second chamber 70. The first chamber 75 is proximate the wall 12 of the housing 10 and includes an interior volume 77 that is configured to receive grain therein. It should be understood within the scope of the present invention that the grain drying apparatus 100 could have alternate sizes and shapes of the first chamber 75. Intermediate the first chamber 75 and second chamber 70 is wall 80. Wall 80 is structured so as to facilitate airflow therethrough. It is contemplated within the scope of the present invention that the wall 80 could be structured in various manner in order to permit air to flow therethrough to include but not limited to a plurality of apertures.

The second chamber 70 is operably coupled to the heating chamber 40 and is configured to receive hot air therefrom. The second chamber 70 is adjacent the first chamber 75 and has an interior volume 72 that is reduced in size as compared to the interior volume 30 of the housing 10. The design of the second chamber 70 and its smaller interior volume 72 allows for utilization of the heating coil assembly 50 and the photovoltaic panel 60. As heating elements 51 require significant amperage, the second chamber 70 has been designed to have a interior volume 72 that can be heated to a desired temperature to dry grain with the heating coil assembly 50. This provides the necessary drying and reduces the amount of heat production required and as such the existing system has proven effective. The hot air egresses the interior volume 30 after passing through the grain disposed in the first chamber 75 through the roof vents 15.

While a diagrammatic view of the present invention has been illustrated herein in FIG. 3, it should be understood within the scope of the present invention that the configuration, shapes and sizes of the first chamber 75 and second chamber 70 could be altered and still achieve the desired functionality as described herein. Additionally, as is illustrated in FIG. 2 herein, it is contemplated within the scope of the present invention that the grain drying apparatus 100 could have more than one heating chamber 40 operable to introduce hot air into the interior volume 30. An auger 90 is present at the bottom of the housing 10 and is configured to rotate and facilitate the removal of grain ensuing the drying thereof in the first chamber 75.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding description is, therefore, not intended to be limited to the specific forms set forth herein, but on the contrary, it is intended to cover such alternatives, modifications, and equivalents, as can be reasonably included within the spirit and scope of the invention.

What is claimed is:

1. A grain drying apparatus configured to provide reduction of moisture of a grain disposed therein wherein the grain drying apparatus comprises:
a housing, said housing having at least one wall and a roof forming an interior volume;
a first chamber, said first chamber being disposed in the interior volume of the housing, said first chamber having an interior volume, said first chamber being proximate the at least one wall of said housing;
a second chamber, said second chamber being disposed in the interior volume of the housing, said second chamber being adjacent said first chamber distal to the at least one wall, said second chamber having an interior volume, said second chamber having a wall intermediate said second chamber and said first chamber defining separation thereof; and
a heating chamber, said heating chamber being operably coupled to said second chamber so as to provide hot air into the interior volume thereof, said heating chamber having a heating coil assembly disposed therein, said heating coil assembly having a plurality of heating elements operable to provide an increase in temperature of air present within the heating chamber.

2. The grain drying apparatus as recited in claim 1, wherein the heating coil assembly is operably coupled to at least one photovoltaic panel, said at least one photovoltaic panel configured to provide electricity for operation of said heating coil assembly.

3. The grain drying apparatus as recited in claim 2, wherein the heating chamber includes a first end and a second end having a hollow passage in between, said heating chamber having a fan proximate said first end of said heating chamber.

4. The grain drying apparatus as recited in claim 3, wherein the wall intermediate the second chamber and first chamber is configured to permit airflow therethrough.

5. The grain drying apparatus as recited in claim 4, wherein the first chamber and second chamber are substantially disposed around a perimeter of the interior volume of the housing.

6. The grain drying apparatus as recited in claim 5, wherein the housing further includes an auger disposed at a bottom thereof that is configured to facilitate removal of grain from the first chamber.

7. A grain drying apparatus configured to provide reduction of moisture of a grain for storage thereof wherein the grain drying apparatus comprises:
a housing, said housing having at least one wall, a bottom and a roof forming an interior volume, said roof having at least one vent configured to provide egress of air within the interior volume of the housing;
a first chamber, said first chamber being disposed in the interior volume of the housing adjacent the at least one wall of the housing, said first chamber having an interior volume, said first chamber being configured to receive grain therein;
a second chamber, said second chamber being disposed in the interior volume of the housing, said second chamber being adjacent said first chamber opposite the at least one wall, said second chamber having an interior volume, said second chamber having a wall intermediate said second chamber and said first chamber defining separation thereof, said wall being configured to permit airflow therethrough; and
a heating chamber, said heating chamber being operably coupled to said second chamber so as to provide hot air into the interior volume thereof, said heating chamber having a first end and a second end, said heating chamber having a hollow passage intermediate said first end and said second end, said heating chamber being operably coupled to said second chamber so as to provide hot air thereinto;
a heating coil assembly, said heating coil assembly being disposed within the hollow passage of said heating chamber, said heating coil assembly having a plurality of heating elements operable to provide an increase in temperature of air present within the heating chamber.

8. The grain drying apparatus configured to provide reduction of moisture of a grain for storage thereof as recited in claim 7, wherein the heating coil assembly is operably coupled to a photovoltaic power source, said photovoltaic power source configured to provide electricity for operation of said heating coil assembly.

9. The grain drying apparatus configured to provide reduction of moisture of a grain for storage thereof as recited in claim 8, and further including a fan, said fan being proximate said first end of said heating chamber, said fan operable to move air from the heating chamber into the interior volume of said second chamber.

10. The grain drying apparatus configured to provide reduction of moisture of a grain for storage thereof as recited in claim 9, wherein the first chamber and second chamber extend substantially around a perimeter of the housing.

11. The grain drying apparatus configured to provide reduction of moisture of a grain for storage thereof as recited in claim 10, wherein the interior volume of the housing includes a void bordered by the second chamber.

12. The grain drying apparatus configured to provide reduction of moisture of a grain for storage thereof as recited in claim 11, and further including an auger, said auger disposed at the bottom of said housing and is configured to facilitate removal of grain from the first chamber.
